(19) United States
(12) Patent Application Publication
(10) Pub. No.: US 2026/0138223 A1
(43) Pub. Date: May 21, 2026

(54) CHIP COLLECTION BOX FOR CUTTING TOOL

(71) Applicant: Hilti Aktiengesellschaft, Schaan (LI)

(72) Inventors: Junsong ZHOU, Shanghai (CN); Yu YANG, Shanghai, Songjiang district (CN); Sven GRUMBRECHT, Shanghai (CN)

(21) Appl. No.: 19/120,051

(22) PCT Filed: Oct. 13, 2023
(86) PCT No.: PCT/EP2023/078511

§ 371 Date: Apr. 10, 2025

(30) Foreign Application Priority Data
Oct. 26, 2022 (CN) 202211315304.8

(51) Int. Cl. B23Q 11/00; B23D 45/16; B23D 59/00

(52) U.S. Cl. CPC B23Q 11/0071; B23D 45/16; B23D 59/006

(57) ABSTRACT

A chip collection box for a cutting tool, the cutting tool including a cutter for performing a cutting operation and a protective cover at least partially covering the cutter, a chip guiding channel being provided in the protective cover, the chip collection box being attached to the protective cover and having a chip collecting inlet in communication with the chip guiding channel, a chip collection chamber for receiving chips, and a chip collecting outlet for discharging the chips, and the chip collection chamber being provided with at least one chip overflow port. The chip collection box for a cutting tool allows, when too many chips are accumulated in the chip collection chamber, at least part of the chips to automatically overflow from the chip overflow port, thereby avoiding the risk of the chips clogging the cutter or melting the chip guiding channel due to further accumulation of the chips in the chip guiding channel.

### TECHNICAL FIELD

The present invention relates to a cutting tool, and in particular to a chip collection box for a cutting tool.

### BACKGROUND ART

Hand-held cutting tools are widely used power tools for cutting workpieces such as wood, metal and many other materials. Typically, the hand-held cutting tools include a variety of power tools having rotary cutters for cutting workpieces to be machined, such as circular saws, angle grinders, planers, etc. During cutting with the above-mentioned cutting tools, the materials removed from the workpieces, such as chips or dust, are brought to scatter due to the rotation of the cutters. Therefore, the cutting tools are generally connected to a chip collection box for collecting flying chips or dust.

### SUMMARY OF THE INVENTION

For a hand-held cutting tool, an appropriate size and weight needs to be maintained to facilitate a hand-held operation, and accordingly, the chip collection box for the cutting tool should also have a small and delicate structure. When the cutting tool completes one or multiple cutting operations, the chip collection box attached thereto is gradually fully filled with the accumulated flying chips or dust, or even the chip collection box would have been fully filled during a single cutting operation. In this case, it is necessary to discharge the chips or dust from the chip collection box in time, otherwise the chips may clog in a protective cover of the cutting tool, affecting the normal operations of the cutting tool.

Existing chip collection boxes are usually closed, it is difficult for a user to directly observe the amount of chips accumulated in the chip collection box, sometimes, the user forgets to check whether the chip collection box containing the chips is full, accordingly, the user does not notice that the chip collection box is already fully filled with the chips and continues operating the cutting tool, and the risk of the chips clogging the cutter may occur. Furthermore, when the cutting tool performs a high-speed cutting operation, the temperature of the resulting chips is very high, and particularly when the cutting tool is used for machining metal pieces, the high temperature of metal chips entering the chip collection chamber may cause an increase in the temperature of the entire chip collection chamber, or even scalding. If the chips in the chip collection chamber are not cleaned in time, the high-temperature chips may also lead to the risk of melting or damaging a chip guiding channel of the protective cover or even the chip collection chamber when being accumulated at a chip collecting inlet.

An object of the present invention is to provide a chip collection box for a cutting tool, which is capable of automatically discharging part of the chips when there is an excessive amount of chips accumulated in the chip collection box.

A The present invention provides a chip collection box for a cutting tool, the cutting tool comprising a cutter for performing a cutting operation and a protective cover at least partially covering the cutter, a chip guiding channel being provided in the protective cover, the chip collection box being attached to the protective cover and having a chip collecting inlet in communication with the chip guiding channel, a chip collection chamber for receiving chips, and a chip collecting outlet for discharging the chips, and the chip collection chamber being provided with at least one chip overflow port.

According to an embodiment of the present invention, the chip collection chamber comprises a first side wall facing the side on which an electric motor is mounted, an opposite second side wall, a rear side wall facing a user, a bottom substantially facing a workpiece to be cut, and a top connected to the chip collecting inlet and substantially opposite to the bottom, the chip overflow port being provided in an end of the second side wall and/or the rear side wall close to the top.

According to a preferred embodiment of the present invention, the chip overflow port is a continuous opening.

According to a preferred embodiment of the present invention, at least a part of the second side wall and/or the rear side wall forms a bevel tilting toward the interior of the chip collection chamber, and the chip overflow port is located at the top end of the bevel. Preferably, the bevel has an angle of inclination between 5 and 45 degrees.

According to another preferred embodiment of the present invention, the chip overflow ports are openings uniformly distributed in an upper portion of the second side wall and/or the rear side wall.

According to another embodiment of the present invention, the chip collecting outlet is provided in the second side wall, the bottom or the rear side wall, and is opened or closed by a pivotable door. Preferably, the entire door forms the second side wall, and the chip overflow port is provided in the door.

According to a further embodiment of the present invention, the top of the chip collection chamber is further provided with a vent.

The chip collection box for a cutting tool of the present invention, providing the chip overflow port at the end of the side wall or the rear wall of the chip collection chamber close to the chip collecting inlet allows the chips in the chip collection chamber to overflow from the chip overflow port when being gradually accumulated to the extent that the chip collection chamber is full, thereby avoiding the risk of the chips clogging the cutter or melting the chip guiding channel due to further accumulation of the chips in the chip collecting inlet.

### BRIEF DESCRIPTION OF THE DRAWINGS

A better understanding of the embodiments mentioned can be gained from the following detailed description with reference to the drawings. It is emphasized that the various components are not necessarily drawn to scale. In fact, dimensions may be increased or decreased at will for the purpose of clear description. In the drawings, the same reference numerals refer to the same elements.

FIG. 1 is a schematic overall view of a chip collection box for a cutting tool according to an embodiment of the present invention mounted to the cutting tool;

FIG. 2 is a cross-sectional view of the chip collection box for a cutting tool shown in FIG. 1 mounted to the cutting tool;

FIG. 3 is a schematic view of a chip collection box according to an embodiment of the present invention;

FIG. 4 is schematic cross-sectional view of the chip collection box shown in FIG. 3; and

FIG. 5 is a schematic view of a chip collection box according to another embodiment of the present invention.

### DETAILED DESCRIPTION

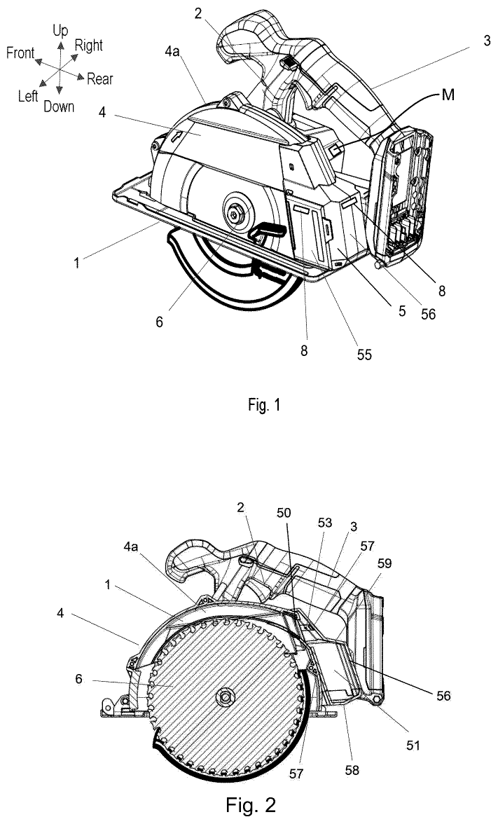

A chip collection box for a cutting tool according to embodiments of the present invention will be described below with reference to FIGS. 1-4. The terms “front”, “rear”, “above”, “below”, “left” and “right” in the present invention are used throughout this description to define various parts of the cutting tool when arranged in an orientation in which it is desired to be used, such as the orientation shown in FIG. 1.

According to an exemplary embodiment of the present invention, the cutting tool includes, but is not limited to, a hand-held circular saw 1. As shown in FIGS. 1-2, the circular saw comprises a housing 2, a handle 3 mounted on the outside of the housing H, an electric motor M (shown solely schematically) mounted inside the housing 2, a protective cover 4 at least partially covering the cutting tool 6, and a chip collection box 5 attached to the protective cover 4. As shown in FIGS. 1-2, a chip guiding channel 4a is formed in the protective cover 4, the chip guiding channel 4a is substantially located above teeth of a cutting blade 6. The handle 3 is mounted above the housing 2 adjacent to the right side of the protective cover 4 and is substantially parallel to an operating direction of the circular saw, namely, a front-rear direction. The chip collection box 5 is detachably attached to a rear end of the protective cover 4, optionally by means of a groove design, the chip collection box 5 slides into a set position from an upper end of the protective cover, namely, being mounted in place, along the groove on the protective cover.

Referring to FIGS. 2 to 4, the chip collection box 5 has a chip collecting inlet 50, a chip collection chamber 51 for receiving the chips, and a chip collecting outlet 52 for discharging the chips. When the circular saw 1 performs a cutting operation, a user holds the handle 3, a saw blade cuts a workpiece while moving forwards, during which, chips generated during the cutting of the workpiece are thrown into the chip collecting inlet 50 of the chip collection box 5 along the chip guiding channel in the protective cover 4. A guide channel 53 is provided between the chip collecting inlet 50 and the chip collection chamber 51, and the guide channel 53 is in communication with the chip collecting inlet 50 and the chip collection chamber 51.

The chip collection chamber 51 comprises a first side wall 54 facing the side of the circular saw on which an electric motor is mounted (i.e., the right side in FIG. 1), and a second side wall 55 (see, e.g., the left side in FIG. 1) opposite to the first side wall 54, a rear side wall 56 facing the user, an engagement face 57 facing the rear end of the protective cover 4, a bottom 58 substantially facing the cut workpiece, and a top 59 opposite to the bottom, the top 59 being connected to the guide channel 53. The chip collection chamber 51 is configured as a generally square cavity having a recess for receiving the rear end of the protective cover.

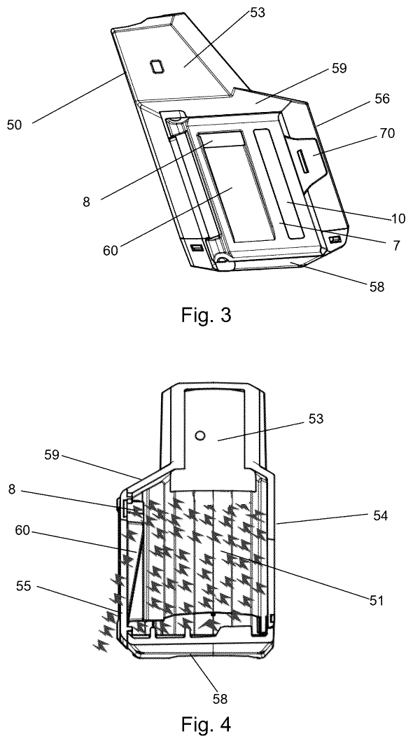

The chip collection chamber 51 is further provided with at least one chip overflow port 8 (see, e.g., FIG. 3) for allowing at least part of the chips to be automatically discharged from the chip collection box when the chips in the chip collection chamber are accumulated to the level of the chip overflow port 8 without opening the chip collecting outlet. Since the chip collection chamber 51 is located below the guide channel 53, by providing the chip overflow port in the chip collection chamber, the chips in the chip collection chamber will not be further accumulated upwards after reaching the location of the chip overflow port. Therefore, the risk of the chips being accumulated in the guide channel 53 for communicating the chip collecting inlet 50 with the chip collection chamber 51 is avoided, and the risk of the chips clogging the cutter and high-temperature chips causing the protective cover or even the chip collection chamber to be melted is also avoided. Even if the user neglects to observe and clean the chip collection box, the chips will still automatically overflow from the chip collection box when being accumulated to the level of the chip overflow port 8.

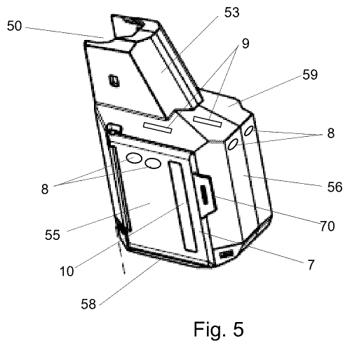

According to an embodiment of the present invention, as shown in FIGS. 2 and 4, the chip overflow port 8 is formed in the end of the upper portion of the second side wall 55 and/or the rear side wall 56 close to the top 59. Since the first side wall 54 faces the electric motor when the dust collection box is mounted to the cutting tool, it is desirable that no chip leakage between the electric motor and the chip collection box occurs. The second side wall 55 and the rear side wall 56 are generally exposed to the user and are therefore preferred side walls for providing the chip overflow port therein. The chip overflow port is provided in the second side wall 55 and/or the rear side wall 56, so that a chip removal function is achieved without affecting the normal use of the cutting tool. Preferably, the chip overflow port 8 is provided in the second side wall 55. Since the user tends to stand behind the cutting tool when using the cutting tool, the second side wall 66 is a side face in front left of the user, and the provision of the chip overflow port 8 in this side face will have a minimal impact on the use of the cutting tool.

More preferably, the chip overflow port 8 is provided in the end of the side wall of the chip collection chamber close to the top, so that the chip overflow port 8 is located substantially at the highest position in the chip collection chamber 51 in a vertical direction, that is to say, part of the chips will not be discharged from the chip overflow port until the entire chip collection chamber is fully filled with the chips. When the user notices that there are chips overflowing from the chip overflow port 8, that is, the user knows that the chip collection chamber is about to be fully filled with the chips, the user will clean the chips in time. The chip overflow port 8 provided thus further functions to prompt the user to clean the chip collection box to a certain extent. In addition, the chips generated during the cutting operation are thrown, under the drive of an airflow, into the chip collection chamber through the chip collecting inlet 50 along the chip guiding channel 4a in the protective cover. Therefore, the chips are entrained by high-temperature air when entering the chip collection chamber, the temperature of the chips and the airflow just entering the chip collection chamber can be up to 100° C., and the side wall of the chip collection chamber accordingly becomes hot under the effects of the chips and the airflow, and there will be a risk of scalding if the user inadvertently touches the side wall of the chip collection chamber. Therefore, providing the chip overflow port 8 in the end of the side wall of the chip collection chamber close to the top also helps to discharge the hot airflow, preventing the side wall of the chip collection chamber from being at an excessively high temperature.

Preferably, the chip overflow port 8 is a continuous opening. A suitable shape is selected depending on the shape and size of the side wall, such as a rectangular shape, an oval shape, a parallelogram shape, an arc shape, or a curved shape, etc. More preferably, the area of the opening is not more than ⅓ of the area of the second side wall or the rear side wall. The chip overflow port with such a configuration and size makes it more efficient to discharge excessive chips, while excessive discharge of the chips during the cutting operation is prevented from affecting the cleanliness of a workplace.

Referring to FIGS. 3-4, at least a part of the second side wall 55 forms a bevel 60 tilting toward the interior of the chip collection chamber, and the chip overflow port 8 is located in the top end of the bevel. The bevel 60 herein plays a guiding role. When the height of the chips accumulated in the chip collection chamber is flush with the chip overflow port 8, namely, the level of accumulation of the chips is flush with the top end of the bevel 60, in this case, the chips can easily flow out through the chip overflow port 8 along the bevel 60 when further increasing. Preferably, the bevel has an angle of inclination between 5 and 45 degrees. An excessively large angle of inclination will affect the available space of the chip collection chamber, while an excessively small angle of inclination has a limited guiding effect. Therefore, the angle of inclination between 5 and 45 degrees can ensure the available space of the chip collection chamber and also provide a good guiding effect.

With regard to the embodiment shown in FIGS. 3-4, which is a schematic view illustrating the chip overflow port 8 provided in the second side wall 55, it will be appreciated that when the chip overflow port 8 is provided in the rear side wall 56 or in the second side wall 55 and the rear side wall 56, the chip overflow port may have the same structural features and functions as described above, and it is particularly advantageous for the cutting tool to be inclined at a certain angle for a machining operation. For example, the cutter is operated in the vertical direction, rather than moving in a front-rear direction as shown in FIG. 1, and in this case, providing the chip overflow port 8 in the upper portion of the rear side wall 56 further facilitates easy discharge of excessive accumulated chips.

The chip collecting outlet 52 may be provided in the second side wall, the bottom, or the rear side wall and is opened or closed by means of a pivotable door 7. For example, in the embodiments shown in FIGS. 1-4, the chip collecting outlet 52 is provided in the second side wall 55 of the chip collection chamber, namely, the side facing away from the electric motor and the handle (the left in FIG. 1), and the chip collecting outlet 52 is opened or closed by means of the pivotable door 7. Such an arrangement has the advantage that the user can easily discharge the chips from the chip collecting outlet only by simply turning the cutting tool to the left, such as by 90 degrees. The door 7 covers the entire second side wall and may alternatively be a part of the second side wall. The door 7 is further provided with a lock catch 70, the lock catch maintains the door 7 in a closed state when being engaged with the chip collection chamber, and the door 7 can be opened by unlocking the lock catch 70. Preferably, the chip overflow port 8 is provided in the door 7. The chip collecting outlet is opened or closed by means of the pivotable door 7, so that the overall structure of the chip collection box can be made small and exquisite. Alternatively, the chip collecting outlet may be opened or closed by means of a sliding door or a drawer structure. Preferably, the door is provided with a transparent viewing window 10 to observe the amount of chips accumulated in the chip collection chamber.

According to another preferred embodiment of the present invention, as shown in FIG. 5, the chip overflow ports 8 are a plurality of openings uniformly distributed in the upper portion of the second side wall and/or the rear side wall in order to increase the efficiency of overflow of the excessive chips accumulated in the chip collection chamber from the chip collection chamber.

Preferably, the top of the chip collection chamber is further provided with a vent 9. The entry of the high-temperature chips into the chip collection chamber results in a consequent increase in the temperature of the air in the chip collection chamber, and forming the appropriate vent 9 in the top 59 is conductive to the discharging of the overheated air entrained by the chips thrown during cutting.

As described above, although exemplary embodiments of the present invention have been explained herein with reference to the drawings, the present invention is not limited to the specific embodiments described above, and may have many other embodiments. The scope of the present invention should be defined by the claims and their equivalent meanings.

1-9. (canceled)

10. A chip collection box for a cutting tool having a cutter for performing a cutting operation and a protective cover at least partially covering the cutter, a chip guiding channel being provided in the protective cover, the chip collection box being attached to the protective cover, the chip collection box comprising:
a chip collecting inlet in communication with the chip guiding channel;
a chip collection chamber for receiving chips;
a chip collecting outlet for discharging the chips; and
at least one chip overflow port.

11. The chip collection box as recited in claim 10 further comprising a first side wall facing a side where an electric motor is mounted, an opposite second side wall, a rear side wall facing a user, a bottom facing a workpiece to be cut, and a top connected to the chip collecting inlet and opposite to the bottom, the chip overflow port being provided in an end of the second side wall or the rear side wall at the top.

12. The chip collection box as recited in claim 11 wherein the chip overflow port is a continuous opening.

13. The chip collection box as recited in claim 11 wherein at least a part of the second side wall or the rear side wall forms a bevel tilting toward an interior of the chip collection chamber, and the chip overflow port is located at a top end of the bevel.

14. The chip collection box as recited in claim 13 wherein the bevel is at an angle of inclination of 5 to 45 degrees.

15. The chip collection box as recited in claim 11 wherein the at least one chip overflow port includes a plurality of chip overflow ports being openings uniformly distributed in an upper portion of the second side wall or the rear side wall.

16. The chip collection box as recited in claim 11 wherein the chip collecting outlet is provided in the second side wall, the bottom or the rear side wall, and is opened or closed by a pivotable door.

17. The chip collection box as recited in claim 16 wherein the door forms an entirety of the second side wall, and the chip overflow port is formed in the door.

18. The chip collection box as recited in claim 19 wherein the chip collection chamber is further provided with a vent.
